(19) United States
(12) Patent Application Publication
(10) Pub. No.: US 2010/0025883 A1
(43) Pub. Date: Feb. 4, 2010

(54) Method for manufacturing a hose

(76) Inventor: John Mobley, Lexington, TN (US)

Correspondence Address: MARSHALL & MELHORN, LLC, FOUR SEAGATE - EIGHTH FLOOR, TOLEDO, OH, 43604, US

(21) Appl. No.: 12/587,660

(22) Filed: Oct. 9, 2009

Related U.S. Application Data
(62) Division of application No. 11/494,701, filed on Jul. 27, 2006.

(51) Int. Cl. B29C 39/00

(52) U.S. Cl. 264/171.12; 264/212

(57) ABSTRACT

A method of manufacturing a cured, non-reinforced hose exhibiting one or more desirable configuration features molded onto the outer surface of the hose; and a cured, non-reinforced hose exhibiting such desirable configuration features molded on the outer surface thereof, manufactured in accordance with such method are described. The method comprises: providing a raw, non-reinforced polymeric tubular structure having an outer surface, an inner surface, an orifice, and a cylindrical channel extending longitudinally throughout the raw tubular structure defining the inner surface of the raw polymeric tubular structure; providing a mold apparatus having a cavity configuration corresponding to the shape and size of a desired cured, non-reinforced hose; inserting the raw polymeric tubular structure into the cavity configuration of the mold apparatus; inserting a first plug means having an aperture therethrough into a first end of the raw polymeric tubular structure; inserting a second plug means having an aperture therethrough into a second end of the raw polymeric tubular structure; providing a source of steam under elevated pressure to cure the raw polymeric tubular structure, wherein the first plug means having an aperture therethrough serves as an inlet for the steam and the second plug having an aperture therethrough serves as an outlet for the steam; and recovering a cured, non-reinforced hose having an inner surface and an outer surface, wherein the outer surface exhibits one or more desirable characteristic features molded onto the outer surface of the cured, non-reinforced hose.

### RELATED APPLICATIONS

This application is a division of Ser. No. 11/494,701, filed Jul. 27, 2006, which is incorporated by reference in its entirety and which is pending as of the filing date of this application.

### FIELD OF THE INVENTION

The present invention relates to a method of forming and curing hose and particularly, to a method of forming multi-layer, non-reinforced hose which are useful in the automotive industry, and to a hose produced by such method. The method, in accordance with the invention, provides a hose having an outer surface exhibiting one or more external features that are desirable in automotive hoses.

### BACKGROUND OF THE INVENTION

It is known in the art to manufacture flexible polymeric hose for use in the automotive industry to convey fluids. Typically, such hose is manufactured by placing a pre-cut length of uncured hose onto a pre-heated mandrel, which is generally shaped to provide the desired configuration of the hose. The mandrel is then heated under conditions of heat and pressure to cure the hose. When the hose is cured it substantially retains the general shape of the mandrel. One such method is described in U.S. Pat. No. 4,537,394. Producing such hoses on a mandrel is difficult and time consuming due to the manual functions of installing the uncured hose on the mandrel and then removing the hose from the mandrel after curing. Furthermore, the removal of the cured hose frequently causes damage to the cured hose and/or the mandrel resulting in scrapping of the hose and, in some instances, replacement of the mandrel, resulting in excessive manufacturing costs.

It is also known, as disclosed in U.S. Pat. No. 4,218,420, to manufacture flexible polymeric hose in a hose curing apparatus having a pair of preformed, re-useable confining wall structures defining a spiral groove in which the hose is placed and cured. The disclosed method provides a cured hose having a uniform outside surface. However, in the ever increasing complex world of automotive technology where performance and space are critical, it is highly desirable to provide fluid transporting hoses which are not only capable of performing their required tasks, but which are configured with one or more desirable features which heretofore have been impossible to obtain using prior art methods of manufacturing cured automotive hoses.

Thus, it is highly desirable to provide a flexible automotive hose for use as fuel filler and radiator hoses which contains convolutes, one or both end chamfered or flared and/or informative indicia such as identifying marks and signs, e.g., designs, words, numerals, etc. at predetermined locations on the outer surface of the hose

### SUMMARY OF THE INVENTION

The present invention is directed to a method for curing multi-layer, non-reinforced hoses which are particularly useful in automotive applications and to the cured, multi-layer, non-reinforced hose manufactured in accordance with such method. According to the present invention, raw or uncured hose is inserted into a first half of a two-piece mold configured to the specific pre-determined dimensions and configuration for the completed hose. A plug is inserted into each end of the hose for the purpose of forming and controlling the inner diameter of the hose. The plug is provided with an orifice in each end of the plug as inlet and outlet means for steam used in the curing of the hose. After the plugs are inserted into the ends of the uncured hose and the hose is inserted into the first half of the mold, the second half of the mold is placed on the first half to begin the curing and forming cycle. The mold containing the uncured hose is heated, for example, in a press with heated platens that can be heated with either steam or electricity or any other source of power. The typical temperature of the mold is about 250 to 350.degree. F. and the closing force of the press is typically about 10 to 30 tons. A typical cure is between about 3 and 10 minutes.

Accordingly, it is an object of the present invention to provide a simple and inexpensive method of manufacturing a multi-layer, non-reinforced hose suitable for use in automotive applications such as, for example, fuel filler hose and radiator hose, wherein the hose exhibits one or more desirable characteristic features molded onto the outer surface of the hose.

It is another object of the present invention to provide a method of manufacturing a multi-layer, non-reinforced hose having a one or more convolute configurations molded onto the outer surface of the hose at one or more predetermined locations.

It is still another object of the present invention to provide a method of manufacturing a multi-layer, non-reinforced hose having a chamfer or flair molded onto the outer surface of the hose at one or both ends of the hose.

It is yet another object of the present invention to provide a method of manufacturing a multi-layer, non-reinforced hose having desirable informative indicia such as words, e.g., “inlet” and/or “outlet” molded into the outer surface of the hose.

It is another object of the invention to provide a multi-layer, non-reinforced automotive hose for use in automotive applications such as fuel filler and radiator hoses, wherein the hose exhibits one or more desirable characteristic features molded onto the outer surface of the hose.

Other objects, advantages and applications of the present invention will become apparent to those skilled in the art when the following description of the invention is read in conjunction with the accompanying drawings.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a perspective view of a hose manufactured according to the present invention;

FIG. 2 is an elevational view of the hose of FIG. 1 showing convolutions along the length of the hose;

FIG. 3 is an elevational view of the hose of FIG. 1 showing certain indicia molded into the outer surface of the hose;

FIG. 4 is an elevational view of the hose of FIG. 1 showing the hose of FIG. 1 having one end of the hose being flared;

FIG. 5 is an elevational view of the hose of FIG. 1 showing the hose of FIG. 1 having one end of the hose being beveled or chamfered;

FIG. 6 is an elevational view of the hose of FIG. 1 showing multiple beads on the outer surface of one end of the hose;

FIG. 7 is an exploded perspective view of a mold employed to cure a hose having convolutes on the outer surface of the hose and a flared end in accordance with the present invention;

FIG. 8 is an end view of the mold of FIG. 7; and

FIG. 9 is an exploded perspective view of a hose and the mold for forming the hose in accordance with the invention.

### DETAILED DESCRIPTION OF THE PREFERRED EMBODIMENTS

The present invention describes a method of curing and manufacturing a multi-layer, non-reinforced hose which is useful for conveying liquids. The hose manufactured and cured in accordance with the present invention is particularly useful in the automotive industry as radiator hoses or fuel filler hoses. In carrying out the present invention, a raw or uncured polymeric tubular structure is inserted into a two-piece mold, each half of the mold containing a preformed cavity disposed in one plane. The configuration of each cavity is such that, when the two-piece mold is detachably fastened together, the first and second cavities are in an aligned relationship to define the shape and configuration of the cured hose of this invention.

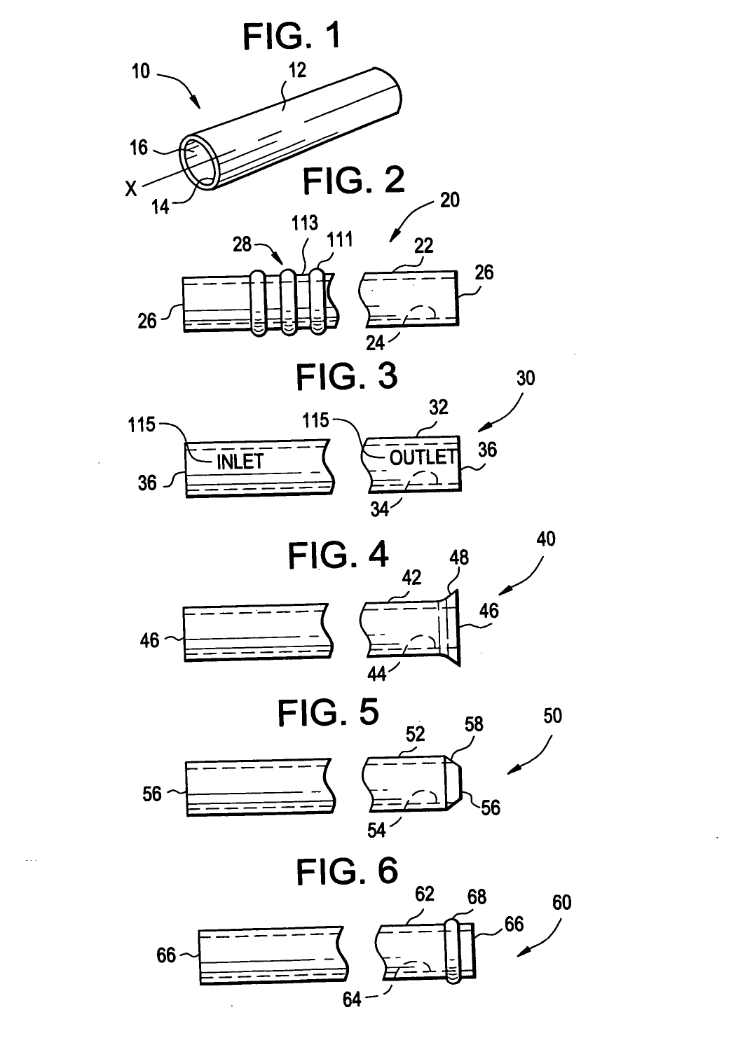

Reference is now made to FIG. 1 of the drawings, which illustrates a raw or uncured tubular structure 10 having an outer surface 12, an inner surface 14 and an orifice 16 extending along the longitudinal axis X of the tubular structure. The raw or uncured tubular structure is prepared by methods generally known in the art, such as extrusion, to provide a raw or uncured tubular structure. The raw or uncured tubular structure is then place into a two-piece mold apparatus having a cavity structure exhibiting the precise configuration of the desired cured, non-reinforced hose of the present invention. The fastened mold structure is adapted to be heated at elevated temperatures and pressures for a period of time to satisfactorily cure the hose. Typically, the temperature of the mold structure is about 250 to 350.degree. F. and the closing force of the press is about 10 to 30 tons. The cure time for the hose in accordance with the present invention is about 3 to 10 minutes, depending on the compound formulation. Accordingly, the cure time of the present method for curing a hose is notably more cost effective than the cure time for prior art pinning processes which require about 30 minutes to achieve effective cure of the hose.

In the manufacture of the hose of the present invention, the mold controls the external configuration and features of the hose which include, but are not limited to, convolutes; informative indicia; flare(s), champfer(s) or bevel(s); and beads on the surface of the cured hose. As shown in FIGS. 2-6, certain desired configurations and characteristics of the cured hose are illustrated. For example, FIG. 2 illustrates one exemplary embodiment of a cured hose of the present invention designated by the numeral 20. The hose 20 includes an outer surface 22, an inner surface 24, an orifice 26 extending along the longitudinal axis of the hose 20 and several convolutes 28 formed circumferentially around the hose 20. The convolutes 28 are formed as extensions of the outer and inner surfaces 22 and 24, respectfully, of the hose 20 forming a series of visual peaks 111 and valleys 113 extending circumferentially on the surface of the hose 20. Typically, but not necessarily, each of the convolutes 28, i.e., the peak 111 and valley 113, is equal in configuration and size to the other convolutes present on the surface of the hose 20. Furthermore, while it is generally preferred that the convolutes 28 are present on the outer surface 22 of the hose 20 in a substantially equal spaced apart relationship, such equal spaced apart relationship is not required in every instance, depending upon the desired overall shape and/or size of the hose. FIG. 3 illustrates another exemplary embodiment of the cured hose of the present invention which is generally designated by the numeral 30 having an outer surface 32, an inner surface 34 and an orifice 36 extending along the longitudinal axis of the hose 30. At predetermined locations along the outer surface 32 of the hose 30, informational indicia 115 such as one or more logos, serial number, part number, date of manufacture, words, e.g., “outlet” and “inlet”, etc. are molded into the outer surface 32 of the hose 30. FIG. 4 illustrates yet another embodiment of the cured hose of the present invention which is generally designated by the numeral 40 having an outer surface 42, an inner surface 44 and an orifice 46 extending along the longitudinal axis of the hose 40. In this embodiment, the hose 40 is molded to exhibit a flared end 48 at one or both ends of the hose 40. The flared end 48 exhibits a circumference having a predetermined diameter which is relatively larger than the tubular body of the hose 40. FIG. 5 illustrates still another embodiment of the cured hose of the present invention which is generally designated by the numeral 50 having an outer surface 52, an inner surface 54 and an orifice 56 extending along the longitudinal axis of the hose 50. In this embodiment, the hose 50 is molded to exhibit a chamfered or beveled end 58 at one or both ends of the hose 40. The chamfered or beveled end 58 exhibits a circumference having a predetermined diameter which is relatively smaller than the tubular body of the hose 50. FIG. 6 illustrates another embodiment of the cured, non-reinforced hose of the present invention which is generally designated by the numeral 60 having an outer surface 62, an inner surface 64 and an orifice 66 extending along the longitudinal axis of the hose 60. At predetermined locations along the outer surface 62 of one or both ends of the hose 60, there is provided one or more beads molded onto the outer surface 62 of the hose 60. The one or more beads extend circumferentially around the outer surface 62 of the hose 60. Each of the one or more beads 68 aids in sealing the hose to a corresponding connector means when the hose is assembled for its intended use.

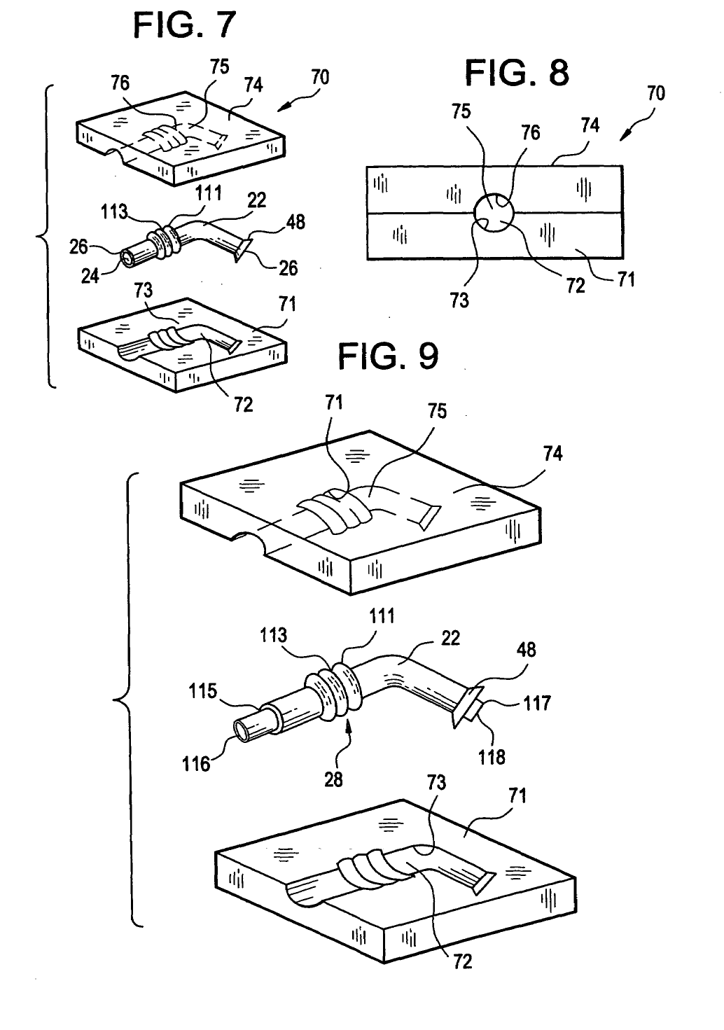

As described above, the molding apparatus controls the external characteristics and features of the cured hose by curing the raw or uncured hose in a preformed die comprising a first upper half and a second lower half. As described and further shown in FIGS. 7-9, each of the halves contains a cavity, the cavity in the first or upper half of the mold corresponds to the upper half of the outer wall structure of the hose and the cavity in the second or lower half of the mold corresponds to the upper half of the outer wall structure of the hose. The cavities can be envisioned as exhibiting the outer surface of a hose which is equally separated in a horizontal plane to provide a first upper half and a second lower half which, when aligned, exhibits the desired shape and size of the outer surface of the cured hose. The apparatus mold also includes any of the features, formations or characteristics which are desired on the outer surface of the cured hose. As seen in FIGS. 7-9, a molding apparatus is designated by the numeral 70. The molding apparatus 70 comprises a first or lower mold structure 71 which has a cavity 72 therein defining a corresponding first wall 73 of a substantially semicircular cross-sectional configuration throughout the general longitudinal length of the cavity 72. The mold apparatus 70 also comprises a second or upper mold structure 74 which has a cavity 75 therein defining a corresponding second wall 76 of a substantially semicircular cross-sectional configuration throughout the general longitudinal length of the cavity 75.

The present method of manufacturing a cured hose uses a mold apparatus heated with steam or electricity to cure and form a raw tubular structure into the shape of a receiving cavity in the mold structure. According to the invention, a raw tubular structure is inserted into a two-piece mold structure. A first plug 115 having an orifice 116 therethrough is inserted into a first end of the raw tubular structure and a second plug 117 having an orifice 118 therethrough is inserted into a second end of the tubular structure. The plugs provide an inlet and outlet for steam under pressure. After the plugs are inserted into the tubular structure, the upper half of the mold apparatus and secured in place by securing means is placed ion the lower half of the mold apparatus. The mold is then heated to a temperature of about 250 to 350.degree. F. and an elevated pressure sufficient to form and cure the hose having a configuration corresponding to the aligned cavities of the mold structure. The closing force of the press is typically about 10 to 30 tons. The cure time in a mold apparatus with steam at the operational conditions of heat and pressure is typically about 3 to 10 minutes and more typically about 4 to 6 minutes. A cure time of about 5 minutes has been found to provide a suitably cured and formed hose.

The raw tubular structure used to form the hose of the present invention can be provided by any of the methods commonly used in the art to form such tubular structures. For example, the tubular structure may be extruded or it may be built-up on a mandrel.

The hose of the present invention is a cured, non-reinforced hose. The absence of reinforcement allows the hose to be easily configured, and thereby provide the desired external characteristics on the outer surface of the hose. Such external characteristics are unobtainable with a reinforced hose because of the inflexibility of the reinforcement. The cured hose of the invention may comprise a single layer or multiple layers, depending on the desired use of the hose. The material used to form a single layer raw tubular structure and the eventual cured hose is determined by the desired application of the cured hose. Typically, the hose is used in industrial applications, particularly, in the automotive industry to convey fluids. Such hoses are especially useful as fuel filler or radiator hoses.

The cured, non-reinforced hose of the invention is a single layer hose or the hose may be formed from multiple layers, depending on the desired application of the hose. Where the cured, non-reinforced hose is a multiple layer hose, the various layers may be the same or they may differ. Typically, the hose is useful in the automotive industry to convey various liquids. Preferably, the hose is employed as a radiator hose or a fuel filler hose.

The material used in the manufacture of the hose of the present invention is any of the polymeric materials commonly used in the manufacture of automotive hoses, such as radiator hoses and fuel filler hoses. Typically, the material is a fluorine-containing polymer such as a homopolymer, copolymer, terpolymer or quadpolymer, or blends thereof. Examples of such polymers include polyvinylidene difluoride (PVDF), polytetrafluoroethylene (PTFE), ethylene-perfluoroethylene-copolymer (EFEP), ethylene-tetrafluoroethylene copolymer (ETFE), vinylidene fluoride-hexafluoropropylene copolymer (FKM), tetrafluorethylene-hexafluoropropylene-vinylidene fluoride terpolymer (THV), blends of tetrafluoroethylene-hexafluoropropylene-vinylidene fluoride terpolymers and vinylidene fluoride-hexafluoropropylene copolymers such as those described in commonly assigned U.S. Pat. Nos. 6,203,873 and 6,365,250, or other elastomeric polymers, such as styrene-butadiene rubber (SBR), nitrile-butadiene rubber (NBR), ethylene-propylene-diene rubber (EPDM), ethylene-propylene rubber (EPR), polyesters such as polyterephthalate, polynaphthalate, etc., polyamides such as nylons, e.g., nylon 4, nylon 6, nylon 11, nylon 12, nylon 66, nylon 610, etc., chlorinated polyethylene (CPE), nitrile-butadiene rubber (NBR), hydrogenated nitrile-butadiene rubber (HNBR), ethylene-vinyl acetate (EVA), epichlorohydrin (ECO), nitrile-butadiene rubber-polyvinyl chloride (NBR-PVC), polychloroprene (CR) and the like.

As indicated above, the cured, non-reinforced hose of the present invention is a single layer hose or a multi-layer hose. In those applications where a hose having multiple layers is preferred, the material used to form the multiple layers of the hose can be the same or different, depending on the specific requirements of the hose. In addition to the various polymeric layers comprising the wall structure of the hose, it may be desirable to provide a protective cover around the outer surface of the hose. Typically, the protective cover is a synthetic elastomer selected from the group consisting of styrene-butadiene rubber (SBR), nitrile-butadiene rubber (NBR), chloroprene rubber, chlorinated polyethylene, chlorosulfonated polyethylene, epichlorohydrin-ethylene oxide rubber, polyvinyl chloride, etc including blends thereof.

It may be desirable and even necessary in certain instances where the various layers are of a different composition or if the various layers are incompatible, to provide an additional layer such as an adhesive which is compatible with both layers, between such incompatible layers. Such additional adhesive layers are well known in the art.

Certain additives may be added to the polymeric material to provide desirable characteristics to the hose. For example, carbon black in any of its various forms may be added to the innermost layer of the hose to provide electrostatic dissipation, particularly in applications involving transportation of hydrocarbon fuels. Other additives include, but are not limited to, fillers, processing aids, antioxidants, stabilizers, lubricants, plasticizers, ant-blocking agents, pigments, extenders, flame retardants, and other additives known in the art of hose manufacture.

It will be recognized by those skilled in the art that changes may be made to the above-described embodiments of the invention without departing from the broad inventive concepts described herein. It is understood, therefore, that this invention is not limited to the particular embodiments disclosed, but it is intended to cover all modifications which are within the scope and spirit of the invention as defined by the appended claims.

What is claimed is:

1. A method of manufacturing a cured, non-reinforced hose exhibiting one or more desirable characteristic features molded onto the outer surface of the hose, said method comprising:
providing a raw, non-reinforced polymeric tubular structure having an outer surface, an inner surface, an orifice, and a cylindrical channel extending longitudinally throughout the raw tubular structure defining said inner surface of said raw polymeric tubular structure; providing a mold apparatus having a cavity configuration corresponding to the shape and size of a desired cured, non-reinforced hose;
inserting said raw polymeric tubular structure into said cavity configuration of said mold apparatus;
inserting a first plug means having an aperture therethrough into a first end of said raw polymeric tubular structure;
inserting a second plug means having an aperture therethrough into a second end of said raw polymeric tubular structure;
providing a source of steam under elevated pressure to cure said raw polymeric tubular structure, wherein said first plug means having an aperture therethrough serves as an inlet for said steam and said second plug having an aperture therethrough serves as an outlet for said steam; and
recovering a cured, non-reinforced hose having an inner surface and an outer surface, wherein said outer surface exhibits one or more desirable characteristic features molded onto the outer surface of said hose.

2. The method of claim 1 wherein said raw, non-reinforced tubular structure is inserted into said cavity configuration of said mold apparatus, wherein said mold apparatus is a two-piece mold structure having a first upper half exhibiting a first cavity configuration corresponding to an upper wall structure of said hose, and a second lower half exhibiting a second cavity configuration corresponding to a lower wall structure of said hose, said first half and second half of said mold apparatus being aligned such that the cavity configuration of said mold apparatus conforms to a desired configuration of said hose.

3. The method of claim 1 wherein said mold is heated in a press at a temperature of about 250 to 350 degree. F. at a closed pressure of about 10 to 30 tons.

4. The method of claim 2 wherein one or both of said first cavity and said second cavity of said mold apparatus further includes one or more die features for providing one or more corresponding desired configurations molded onto said outer surface of said hose.

5. The method of claim 4 wherein said one or more die features includes a convoluted die feature for providing a corresponding convoluted configuration molded onto the outer surface of said hose.

6. The method of claim 4 wherein said one or more die features includes an informational indicia die feature for providing a corresponding informational indicia configuration molded onto the outer surface of said hose.

7. The method of claim 4 wherein said one or more die features includes a uniform groove extending circumferentially around said first cavity and said second cavity for providing a corresponding outwardly extending bead feature molded onto said outer surface at one or both ends of said hose.

8. The method of claim 1 wherein said mold apparatus includes a circumferentially, progressively outward extending configuration at one or both ends of said first cavity and said second cavity for providing a corresponding flared end at one or both ends of said hose.

9. The method of claim 4 wherein said one or more die features includes a circumferentially progressively inward extending configuration at one or both ends of said first cavity and said second cavity for providing a corresponding beveled or chamfered end at one or both ends of said hose.

10. The method of claim 1 wherein said raw, non-reinforced tubular structure comprises one or more layers of polymeric material.

11. A method of manufacturing a single or multi-layer, cured, non-reinforced hose exhibiting a convoluted structure molded onto the outer surface of said cured, non-reinforced hose; informational indicia molded onto the outer surface of said cured, non-reinforced hose adjacent one or both ends of said cured, non-reinforced hose; a first bead molded onto the outer surface of said cured, non-reinforced hose and adjacent said first end thereof; and a second bead molded onto the outer surface of said cured, non-reinforced hose and adjacent said second end thereof, said method comprising:
providing a raw, non-reinforced polymeric tubular structure having an outer surface, an inner surface defining the interior of said raw, non-reinforced tubular structure, an orifice, and a cylindrical channel extending longitudinally throughout the raw tubular structure defining said inner surface of said raw polymeric tubular structure;
providing a two-piece mold apparatus having a first upper half exhibiting a first cavity configuration corresponding to an upper wall structure of said cured, non-reinforced hose, and a second lower half exhibiting a second cavity configuration corresponding to a lower wall structure of said cured, non-reinforced hose, said first half and second half of said mold apparatus being aligned such that the cavity configuration of said mold apparatus conforms to a desired configuration of said cured, non-reinforced hose;
inserting said raw polymeric tubular structure into said cavity configuration of said mold apparatus;
inserting a first plug means having an aperture therethrough into a first end of said raw polymeric tubular structure; inserting a second plug means having an aperture therethrough into a second end of said raw polymeric tubular structure;
providing a source of steam under elevated pressure to said interior of said uncured, non-reinforced tubular structure to form and cure said raw polymeric tubular structure, wherein said first plug means having an aperture therethrough serves as an inlet for said steam and said second plug having an aperture therethrough serves as an outlet for said steam; heating said mold apparatus at a closing force of about 10 to 30 tons and at a temperature of about 250 to 350.degree. F. for about 3 to 10 minutes; and
recovering a cured, non-reinforced hose having an inner surface and an outer surface, wherein said outer surface exhibits a convoluted structure molded onto the outer surface of said cured, non-reinforced hose; informational indicia molded onto the outer surface of said cured, non-reinforced hose adjacent one or both ends of said cured, non-reinforced hose; a first bead molded onto the outer surface of said cured, non-reinforced hose and adjacent said first end thereof; and a second bead molded onto the outer surface of said cured, non-reinforced hose.

12. The method of claim 11 wherein said informational indicia comprises words, logo, numbers and codes.
